(19) United States
(12) Patent Application Publication
(10) Pub. No.: US 2026/0122325 A1
(43) Pub. Date: Apr. 30, 2026

(54) SYSTEM AND METHOD FOR SYNCHRONIZED DUAL SCREEN INTERACTIVE SESSIONS WITH LOCATION-VERIFIED USERS IN PUBLIC VENUES

(71) Applicant: BarBoards LLC, Austin, TX (US)

(72) Inventors: Peter Daniel Limcher, Austin, TX (US); Calvin Wade Giddens, Austin, TX (US); Ben Woods, Austin, TX (US); Richard Theriault, Los Gatos, CA (US)

(21) Appl. No.: 19/375,104

(22) Filed: Oct. 30, 2025

Related U.S. Application Data
(60) Provisional application No. 63/713,749, filed on Oct. 30, 2024.

(51) Int. Cl. H04N 21/8545; G06F 3/14; G06Q 20/20; H04L 9/40; H04N 21/2187; H04N 21/234; H04N 21/242; H04N 21/266; H04N 21/442

(52) U.S. Cl. CPC H04N 21/8545; G06Q 20/20; H04L 63/08; H04N 21/2187; H04N 21/23418; H04N 21/242; H04N 21/266; H04N 21/442; G06F 3/1454

(57) ABSTRACT

A system and method for synchronized dual screen interactive sessions with location-verified user devices in public venues is disclosed. A central controller is positioned between content sources and venue display endpoints. The system monitors live content streams using computer vision analysis to detect optimal intervention opportunities. Upon detecting suitable moments, the system generates contextual interactive content and displays participation invitations with scannable codes on venue displays. User devices scan codes to request participation, with the system verifying physical presence within the venue using location services. For verified users, the system coordinates dual-screen interactive sessions where venue displays present content and user devices serve as input interfaces. The system processes simultaneous responses for competitive scoring, displays results, and integrates with point-of-sale systems for automated reward distribution, enabling enhanced patron engagement in sports bars, restaurants, and entertainment venues.

### CROSS-REFERENCE TO RELATED APPLICATIONS

This application claims the benefit of, and priority to, U.S. Provisional Application No. 63/713,749, filed on Oct. 30, 2024 and titled, “CUSTOMER ENGAGEMENT PLATFORM”, the entire specification of which is incorporated herein by reference.

### BACKGROUND OF THE INVENTION

### Field of the Art

The disclosure relates to the field of interactive entertainment systems and content distribution, and more particularly to the field of content orchestration with location-verified competitive interaction in public venues.

### Discussion of the State of the Art

Public venues such as sports bars, restaurants, hotels, airports, and entertainment establishments have increasingly adopted television displays as primary entertainment infrastructure for patron engagement. These venues typically deploy multiple display endpoints throughout their facilities to broadcast standard programming content including sports events, news, and entertainment programming. However, conventional television distribution systems in public venues operate as passive, one-way broadcast mechanisms that provide limited opportunities for patron interaction or venue-specific content customization.

Traditional content distribution systems in public venues lack analysis capabilities for understanding content streams or automatically determining optimal moments for content intervention. These systems rely on manual channel selection and predetermined programming schedules without the ability to analyze content context, detect natural break points such as commercial segments or halftime periods, or assess audience engagement patterns. This limitation prevents venues from creating seamless interactive experiences that enhance rather than disrupt ongoing programming.

Connected TV and out-of-home advertising systems face substantial measurement and engagement limitations in public venue settings. These systems cannot reliably verify content delivery to specific display endpoints or measure patron engagement in multi-screen environments. Performance tracking remains minimal, and the technical challenges of coordinating targeted content distribution across multiple displays while ensuring proper delivery verification limit the effectiveness of venue-specific advertising and promotional content.

Existing interactive television systems are predominantly designed for residential environments and fail to address the unique technical challenges of coordinating simultaneous multi-user participation in public spaces. Current systems provide multi-user gaming platforms that typically operate in controlled digital environments and lack integration with live television content or coordination with venue display infrastructure.

Therefore, there exists a need in the art for improved content distribution systems that can enhance patron engagement in public venue environments.

### SUMMARY OF THE INVENTION

Accordingly, the inventor has conceived and reduced to practice, in a preferred embodiment of the invention, a system for synchronized dual screen interactive sessions with location-verified user devices in public venues. The system monitors live content streams through computer vision analysis to detect optimal intervention opportunities, generates contextual interactive content based on real-time programming analysis, and coordinates dual-screen interactive sessions between venue display endpoints and authenticated user devices.

According to a preferred embodiment of the invention, the system includes a central controller device positioned between content sources and venue display endpoints, configured with computer vision capabilities for content analysis and a mobile integration component for user device coordination. When the system detects an optimal interactive moment in content streams, a content processing manager generates contextual interactive content comprising questions, challenges, or competitive elements dynamically created from currently displayed programming. An interaction manager displays participation invitations with scannable codes on venue display endpoints to enable user access to interactive sessions.

Location verification services authenticate user device presence within venue premises using GPS-based verification systems and network-based positioning to prevent remote participation by users outside venue boundaries. The system coordinates synchronized dual-screen interactive sessions where venue display endpoints present interactive content simultaneously while user devices serve as personal response input interfaces, maintaining precise timing synchronization across all participants.

The system performs session management to process simultaneous responses from multiple user devices for real-time scoring calculations and dynamic leaderboard updates. When competitive sessions are complete, a point-of-sale (POS) integrator distributes rewards based on scoring calculations and patron ranking, while user analytics components record engagement metrics for venue optimization. This creates a seamless entertainment framework where patron engagement enhances rather than disrupts ongoing programming.

For each interactive session, the system analyzes live content streams to identify optimal intervention opportunities, validates user device location within venue premises, coordinate synchronized dual-screen experiences by transitioning venue display endpoints from participation invitations to interactive content presentation. The system provides individual response interfaces through the user devices for personal input. A synchronization timing is maintained in the user device interactive sessions.

The system maintains venue operations continuity by coordinating seamless transitions back to live content streams while storing engagement analytics. Through continuous content analysis and location-verified participation, it creates an evolving entertainment platform that enhances patron engagement in sports bars, restaurants, hotels, and entertainment establishments without disrupting normal venue operations.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 illustrates an overall system architecture for content orchestration with generation of interaction session between patrons in public venues, according to an embodiment of the invention.

FIG. 6 is a detailed component diagram showing internal architecture of central controller, according to an embodiment of the invention.

FIG. 7 is an exemplary flowchart of a method for enabling interactive sessions in a venue through content orchestration, according to an embodiment of the invention.

FIG. 8 is an exemplary flowchart illustrating a method for competitive interactive session, according to an embodiment of the invention.

FIG. 9 is a exemplary illustration showing a computer vision process implemented within the central controller, according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the inventions(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features.

Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Interactive session” refers to a coordinated interactive experience between multiple venue patrons facilitated through synchronized dual-screen interactive session venue display and endpoints present shared interactive content while user devices serve as individual response input interfaces.

“Contextual interactive content” means dynamically generated questions, challenges, or competitive activities that are automatically created based on real-time analysis of currently displayed primary content, ensuring relevance to ongoing programming.

“Location verification” refers to the technical process of authenticating that user devices are physically present within the venue premises through GPS coordinates, network-based positioning, and venue-specific authentication protocols before permitting participation in interactive sessions.

“Dual-screen interactive sessions” comprise coordinated interactive experiences utilizing two functionally distinct screen types: venue display endpoints that serve as shared visual interfaces presenting interactive content visible to all patrons, and user mobile devices that serve as individual response input interfaces enabling personal participation. The technical coordination maintains synchronized timing between both screen types while processing multiple simultaneous user inputs for competitive scoring and venue-wide result display.

“Real-time sync” refers to the technical capability ensuring all venue display endpoints present identical interactive content simultaneously while maintaining synchronized timing with mobile device interactions across multiple users.

“Competitive interaction” refers to mathematical processing systems that calculate user performance metrics including speed and accuracy scores, generate dynamic leaderboard rankings, and determine competition results across multiple simultaneous participants.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

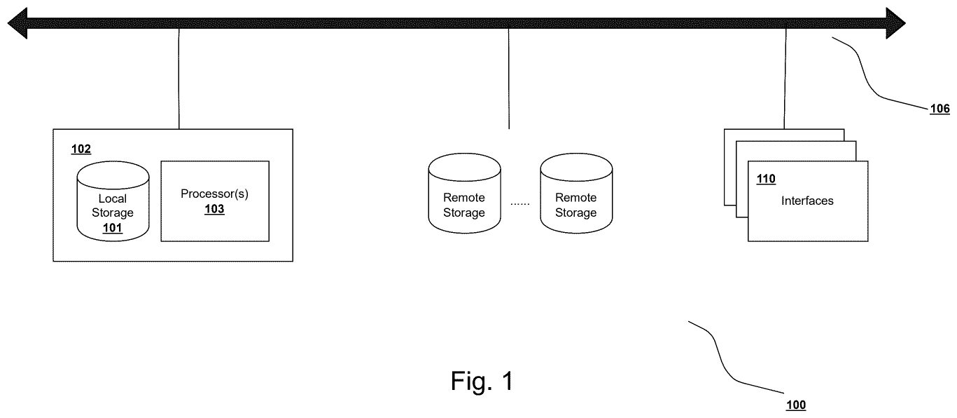

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm®, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm® SNAPDRAGON™ or Samsung® EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

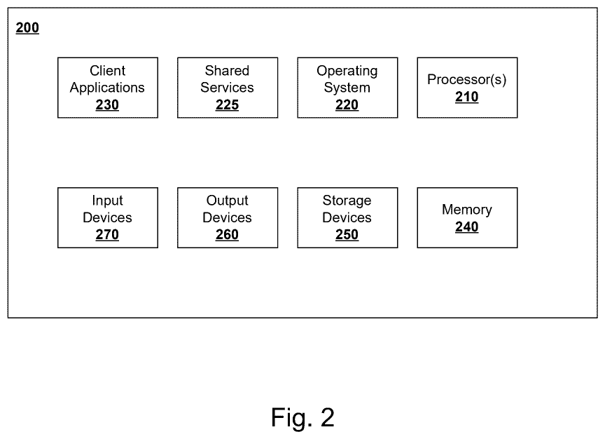

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS® or iOS® operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

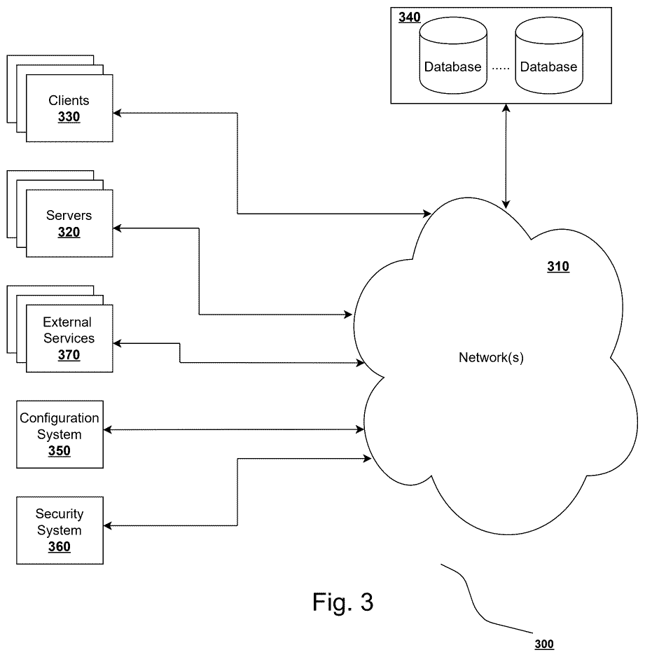

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google Bigtable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database”by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

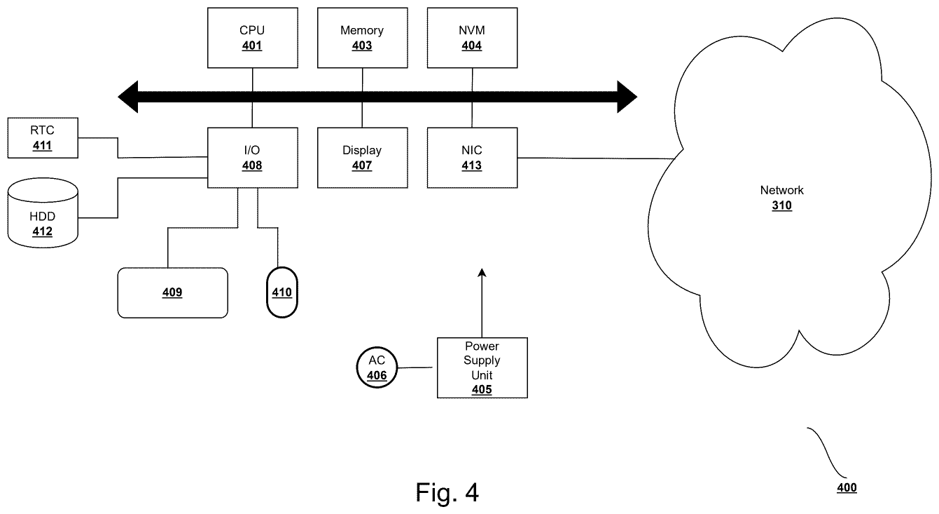

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm® or Samsung® SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

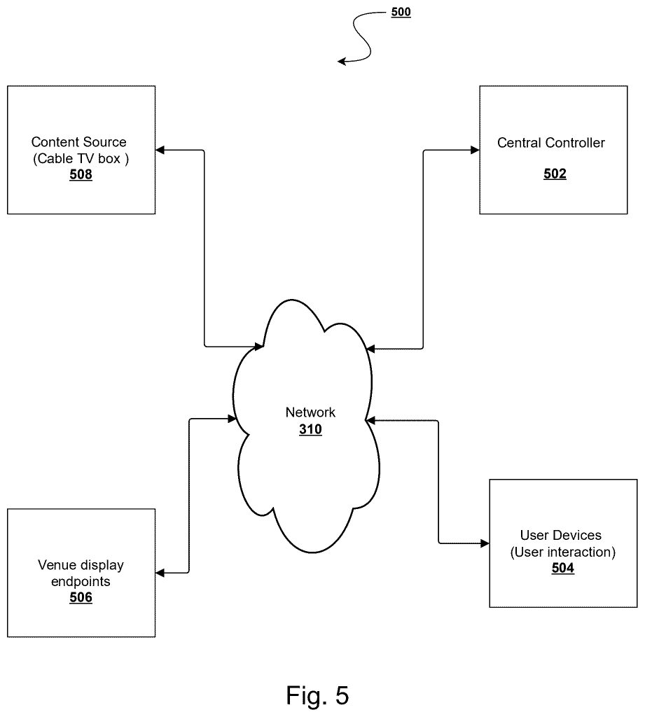

FIG. 5 illustrates an overall system architecture 500 for content orchestration with generation of interaction session between patrons in public venues, according to an embodiment of the invention.

The present invention provides a system for content orchestration in public venues that bridges traditional content distribution with interactive patron engagement. The system operates through a central controller device 500 that functions as an intermediary between content sources and venue display infrastructure, enabling contextual interactive experiences while maintaining the integrity of primary programming content.

In an embodiment, content source 508, may include a cable TV box or streaming content provider, that stream live programming content to central controller 502. Central controller 502 serves as the orchestration platform that coordinates all system components and manages the transformation of passive viewing into active competitive interaction experiences.

In an embodiment, central controller 502 may receive content streams from content source 508 and processes the content through analysis systems to determine optimal moments for interactive content insertion. Central controller 502 implements real-time content switching capabilities while maintaining seamless viewing experience continuity for venue patrons. Central controller 502 maintains bidirectional communication with all connected components while orchestrating content switching and session management.

In an embodiment, venue displays endpoints 506 may include multiple venue display endpoints 506 positioned throughout the venue that present both primary content (live content stream) and interactive content to venue patrons. Display endpoints 506 serve as shared visual interfaces during interactive sessions, presenting questions, challenges, leaderboards, and competition results that are visible to all patrons simultaneously.

In an embodiment, user devices 504 may represent the individual user/patron devices that enable venue patrons to participate in competitive interactive sessions. User devices 504 may communicate with central controller 502 through network 310 to provide location-verified access to interactive sessions and serve as personal response input interfaces during competitive activities.

User devices 504 may include a wide range of mobile computing devices commonly carried by venue patrons, including smartphones, tablets, smartwatches with interactive capabilities, and portable gaming devices with network connectivity. These devices typically include essential hardware components such as GPS receivers for location verification, wireless network interfaces (Wi-Fi, cellular, Bluetooth) for communication with central controller 502, touchscreen displays for response input, cameras for QR code scanning, and sufficient processing power to run dedicated mobile applications or web-based interfaces.

The system is designed to accommodate varying device capabilities through adaptive interface delivery, ensuring that patrons with different user devices 504 can participate in interactive sessions regardless of their specific hardware specifications or operating system versions.

In an embodiment, network 310 facilitates all communication between system components, enabling real-time synchronization between central controller 502, venue displays 506, and user devices 504. The network infrastructure supports simultaneous multi-user interactions while maintaining the timing precision required for competitive interactive sessions.

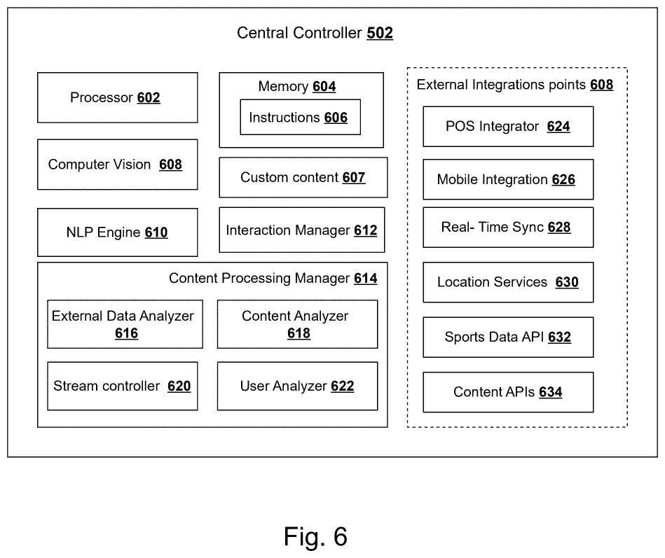

FIG. 6 is a detailed component diagram showing the internal architecture of central controller 502, illustrating the specific technical components that enable content orchestration and interaction session coordination, according to an embodiment of the invention.

### Core Processing Infrastructure

In an embodiment, processor 602 is the central processing unit that executes the instructions 606 stored in memory 604 for system operation and generating custom content 607 for venue-specific interactive elements. Processor 602 may manage real-time content stream analysis, user session coordination, and the complex timing requirements necessary for synchronized dual-screen interactive sessions across multiple venue patrons.

In an embodiment, memory 604 may provide the data storage and buffering capabilities required for real-time content processing and user session management. Memory 604 stores content analysis results, user session data, competitive scoring information, and the temporary data structures necessary for coordinating simultaneous multi-user interactions.

In an embodiment, instructions 606 may contain the executable programming code that implements the content analysis algorithms, user coordination protocols, and interactive sessions. Instructions 606 enable central controller 502 to automatically detect optimal interactive moments and coordinate complex multi-user competitive experiences.

### Content Analysis and Processing Components

In an embodiment, content processing manager 614 may perform content analysis and processing operations. Content processing manager 614 may integrate the outputs from multiple analysis components to make decisions about content switching timing and interactive content generation. The multiple components may be specialized subsystems including external data analyzer 616, content analyzer 618, stream controller 620, and user analyzer 622.

In an embodiment, external data analyzer 616 may processes information from external sources including sports statistics, real-time data feeds, and contextual information that enhances the relevance of generated interactive content. External data analyzer 616 ensures that interactive sessions incorporate current and accurate information relevant to displayed programming.

In an embodiment, content analyzer 618 may examine the structure and content of incoming content streams to identify programming segments, content types, and optimal intervention opportunities. Content analyzer 618 works in coordination with computer vision 608 to provide content understanding capabilities.

In an embodiment, stream controller 620 manages the technical aspects of content switching between primary content and interactive content while maintaining signal quality and timing precision. Stream controller 620 may implement seamless transitions that preserve viewing experience continuity during interactive session launches and conclusions.

### Interaction and Communication Systems

In an embodiment, computer vision 608 may analyze live video content streams to identify content segments, detect optimal intervention moments, and extract contextual information from displayed programming. Computer vision 608 provides advanced image processing capabilities for content analysis and identification of visual elements including game events, commercial breaks, and programming transitions to determine when interactive content insertion will enhance rather than disrupt the viewing experience.

In an embodiment, NLP Engine 610 may process textual and audio content to extract contextual information and generate relevant interactive content. NLP Engine 610 may create contextually appropriate questions and challenges based on real-time content analysis, ensuring that interactive sessions remain directly relevant to currently displayed programming.

In an embodiment, interaction manager 612 may coordinate user-facing interactions including authentication, session management, and competitive coordination between multiple venue patrons. Interaction manager 612 maintains a session state table that tracks authenticated user device identifiers and their corresponding response capabilities, venue display endpoint status and synchronization health, active question timers and response collection windows, participant engagement levels and response history, and real-time scoring calculations that update dynamically as responses are received.

In an embodiment, user analyzer 622 may processes user behavior data, participation patterns, and engagement metrics to optimize interactive session design and timing. User analyzer 622 contributes to the decision-making process that determines when and how to present interactive opportunities to venue patrons.

### External Integration and Support Services

External integration points 608 manage connections to external services and may include point-of-sale (POS) integrator 624, mobile integrator 626, real-time sync 628 and location services 630.

In an embodiment, the system architecture supports extensible application framework through developer-accessible APIs that enable third-party experience creation and venue-specific customization. Central controller 502 may provide integration capabilities that allow venue partners to deploy customized interactive entertainment applications while maintaining consistent technical infrastructure and operational reliability. This modular approach enables venues to tailor patron engagement experiences to their specific demographic and operational requirements while leveraging the core technical capabilities of the interactive content platform.

In an embodiment, POS integrator 624 provides automated connection to venue point-of-sale systems for seamless reward distribution based on competitive session performance. POS integrator 624 may enable automatic application of discounts, loyalty points, and other incentives without requiring manual intervention from venue staff.

In an embodiment, mobile integrator 626 manages communication and coordination with user devices 504 of patrons, including authentication, session coordination, and real-time response processing. Mobile integrator 626 may handle the complex technical requirements of coordinating simultaneous input from user devices 504 during competitive interactive sessions.

In an embodiment, real-time sync 628 ensures that venue display endpoints 506 present identical interactive content simultaneously while maintaining precise timing coordination with mobile device interactions. Real-time sync 628 addresses the technical challenges of coordinating multiple display devices and user devices across potentially complex venue network infrastructures.

In an embodiment, location services 630 may implement GPS-based and network-based verification systems that authenticate user presence within venue premises before permitting participation in interactive sessions. Location services 630 prevent remote participation and ensure that competitive interactions occur only among physically present venue patrons.

In an embodiment, Sports data API 632 may provide access to real-time sports statistics, player information, and game event data that enhances the contextual relevance of generated interactive content. Sports data API 632 enables the creation of highly specific and timely interactive challenges related to ongoing sports programming.

In an embodiment, content APIs 634 may facilitate integration with various content sources and external services that provide programming information, scheduling data, and content metadata. Content APIs 634 expand the system's capability to work with diverse content sources beyond traditional cable television systems.

### System Operation During Interactive Sessions

During operation, central controller 502 continuously monitors content streams using computer vision 608 and content analyzer 618. When optimal interactive moments are identified, content processing manager 614 coordinates with external data analyzer 616 to generate contextually relevant interactive content. Interaction manager 612 orchestrates session launch by coordinating with mobile integrator 626 for user device communication, location services 630 for authentication, and real-time sync 628 for display synchronization. Throughout interactive sessions, stream controller 620 manages seamless transitions between primary content and interactive overlays while user analyzer 622 processes engagement metrics for continuous optimization.

### Detailed Description of Exemplary Embodiments

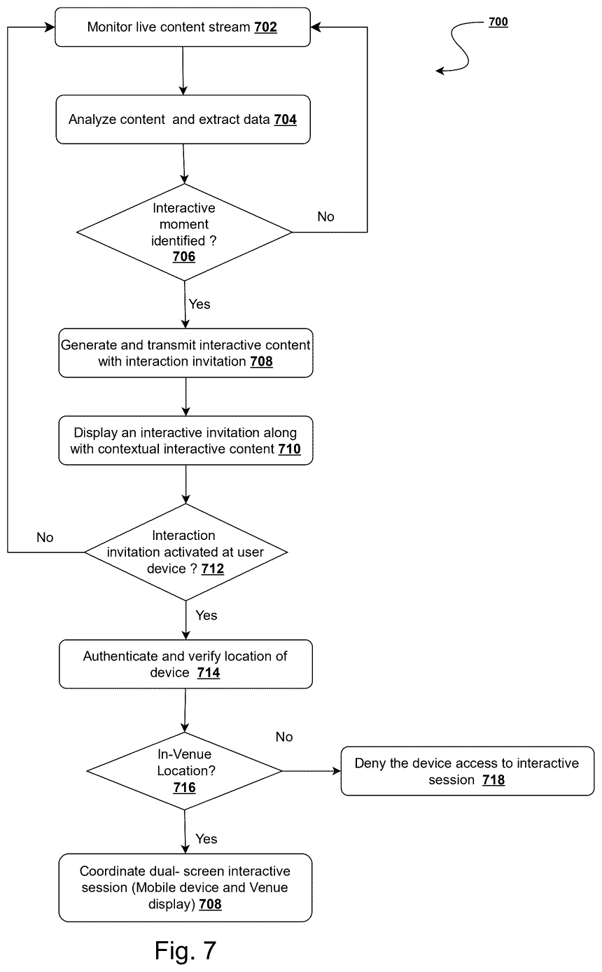

FIG. 7 is an exemplary flowchart of a method 700 for enabling interactive sessions in a venue through content orchestration, according to an embodiment of the invention. The steps of method 700 illustrates how central controller 502 utilizes and coordinates with different subsystems for generating interactive sessions with patrons at a venue.

At step 702, central controller 502 may use computer vision 608 and content analyzer 618 to continuously process incoming content streams from content source 508. Content analyzer 618 performs real-time segmentation analysis while computer vision 608 analysis identifies visual cues including commercial transitions, halftime breaks, and programming boundaries. Stream controller 620 maintains content flow integrity during this analysis phase.

Further, in an embodiment, central controller 502 may incorporate advanced broadcast recognition capabilities through computer vision 608 analysis that enable real-time identification and detection of specific sports events within programming content displayed on venue screens. Computer vision 608 analysis may extract visual event data from ongoing broadcasts, which is then processed by NLP engine 610 to generate contextually relevant interactive challenges corresponding to detected sports events including scoring plays, penalties, and strategic moments in football, basketball, baseball, and other competitive programming. This coordinated analysis ensures that interactive content remains directly relevant to displayed programming rather than generic or disconnected from patron viewing experiences.

Further, computer vision 608 analysis may support sport-specific event recognition capabilities. During football broadcasts, computer vision 608 identifies touchdowns, field goals, and penalty calls. For basketball programming, computer vision 608 detects three-point shots, free throws, and timeout periods. Baseball recognition includes home runs, strikeouts, and inning transitions. Each detected event triggers contextually appropriate interactive content generation that leverages the excitement of the live sports moment.

At step 704, central controller 502 may analyze current content and extracts contextual data including programming events, statistical information, programming segments, and audience engagement indicators. This analysis combines computer vision 608 processing, NLP 616 analysis, and external data integration to create understanding of displayed content and its suitability for interactive enhancement.

At step 706, central controller 502 may determine whether an optimal interactive moment has been identified based on content analysis results and predefined criteria for viewer engagement optimization. The decision process considers factors including content segment boundaries, audience attention levels, and the potential for creating contextually relevant interactive experiences.

For example, during a basketball game timeout, central controller 502 may detect the optimal intervention moment through commercial break recognition. Content processing manager 614 generates a contextual question about the current score differential while venue display endpoints 506 simultaneously present the challenge with participation instructions. Verified patrons receive personalized answer options on their devices, creating venue-wide competitive engagement that resolves before game play resumes.

In an embodiment, central controller 502 may coordinate with content processing manager 614 for evaluating analysis results against predefined criteria using engagement algorithms. User analyzer 622 contributes historical engagement data while external data analyzer 616 provides context relevance scoring to determine optimal interactive timing.

At step 706, when no interactive moment is identified, the method returns to step 702 to continue content monitoring. When an optimal interactive moment is detected, the process advances to step 708 for interactive content generation and session preparation.

At step 708, central controller 502 may generate contextual interactive content with interaction invitation elements based on the analyzed content context. This generation process utilizes computer vision 608 detection results to identify relevant sports events, while NLP engine 610 creates appropriately phrased questions, challenges, or competitive elements that relate directly to the currently displayed programming, ensuring that interactive sessions enhance rather than detract from the viewing experience. Central controller 502 coordinates with content processing manager 614 for generating contextually relevant data. Computer vision 608 provides event detection and timing analysis, external data analyzer 616 supplies current statistics and contextual information, while NLP engine 610 processes this combined data to create natural language questions and challenges stored as custom content 607.

At step 710, interactive participation invitations are presented on venue display endpoints 506, presenting scannable codes and participation instructions that enable venue patrons to access competitive interactive sessions through their user devices 504. The invitation display is coordinated across all venue displays to ensure consistent presentation throughout the venue. Real-time sync 628 coordinates simultaneous presentation across all venue display endpoints 506. Stream controller 620 manages overlay presentation while maintaining primary content visibility, creating seamless integration of interactive invitations.

Consider an example of a venue broadcasting NFL games. When a touchdown occurs during an NFL broadcast, computer vision 608 detects the scoring event while NLP engine 610 generates the question “Which team just scored?” Venue display endpoints 506 present an invitation overlay showing “JOIN THE GAME!” with a prominently displayed QR code. When patrons scan the code with their mobile devices, location services 630 verify they are within the sports bar premises before coordinating the dual-screen interactive sessions.

At step 712, central controller 502 may monitor for interaction invitation activation at user devices, detecting when venue patrons scan participation codes or activate mobile applications to request access to the interactive session. This monitoring process tracks user engagement levels and participation interest across the venue patron population.

Central controller 502 may coordinate with mobile integrator 626 to detect user device connections and scan activations. Interaction manager 612 processes activation requests while tracking participation levels across venue patron population.

At step 712, when interaction invitations are not activated within specified timeframes, central controller 502 may extend invitation periods or return to content monitoring. When activation is detected, the process advances to step 714 for user authentication and location verification.

At step 714, central controller 502 may use location services 630 to authenticate user devices and verify location through GPS coordination and network-based positioning systems. The authentication process ensures that participation requests originate from authorized user devices 504 operated by patrons physically present within the venue premises.

Location services 630 perform authentication using GPS coordinate verification and network-based positioning systems. The authentication process validates user device locations against venue geographic boundaries stored in memory 604.

At step 716, central controller 502 may determine whether requesting user devices are located within venue boundaries through comparison of location data against predefined venue geographic parameters. This verification process prevents remote participation and maintains the integrity of venue-based competitive interactions.

Interaction manager 612 may evaluate location verification results from location services 630, compare user positions against predefined venue parameters to determine participation eligibility.

When location verification fails, method advances to step 718 where device access to interactive sessions is denied, preventing unauthorized participation from users outside venue premises. When location verification succeeds, the process advances to step 720 for interactive session launch and coordination. Mobile integrator 626 transmits access denial notifications to unauthorized devices while interaction manager 612 logs security events for venue analytics.

At step 720, central controller 502 may coordinate synchronized dual-screen interactive sessions through a multi-stage coordination process. A real-time sync 628 broadcasts synchronized timing signals to all venue display endpoints 506 to establish frame-accurate presentation coordination. Simultaneously, mobile integrator 626 establishes bidirectional communication channels with each authenticated user device 504 using connections for real-time data exchange.

In an embodiment, a venue display synchronization process synchronized venue display endpoints 506 to receive identical interactive content packages and coordinate simultaneous presentation timing through network time protocol (NTP) synchronization.

In an embodiment, central controller 502 initiates interactive session with the authenticated user devices 504 by transmitting a personalized interface optimized for device specifications including screen resolution and platform-specific UI elements.

In an embodiment, interaction manager 612 synchronizes response collection windows across heterogeneous user devices 504 and maintains precise timing alignment with venue display content presentation.

During session coordination, central controller 502 may establish communication channels that handle question content distribution to venue displays 506 with visual formatting for optimal viewing distance, answer option delivery to user devices 504 with touch-optimized interface layouts, real-time response data collection with timestamp precision for accurate scoring calculations, and bidirectional synchronization signals that maintain session timing coordination across all participating devices. The coordination process includes failover mechanisms that handle network connectivity issues, device disconnections, and display synchronization failures to maintain session integrity across the venue-wide interactive experience.

Method 600 results in the generation of entertainment environment where ongoing sports programming becomes the foundation for patron interaction. When patrons enter a venue during active sports broadcasting, central controller 502 utilizes the existing excitement of live sports viewing and amplifies patron engagement through synchronized competitive interactive experiences. Each significant sports event including scoring plays, penalties, or strategic moments becomes an opportunity for coordinated venue-wide interaction that builds upon rather than interrupts the natural excitement of sports viewing in public venues.

Consider an example of interactive session that is coordinated during a live sports programming. During live sports programming, when computer vision 608 identifies a significant game event such as a touchdown, central controller 502 generates a relevant trivia question. Venue display endpoints 506 present an overlay containing the question text, multiple choice options visible to all patrons, and a prominent QR code with instructions “Scan to Answer!”. User devices 504 scanning the code receive verification through location services 630, followed by personalized answer interfaces synchronized with the venue display presentation. Response submission creates real-time competitive scoring visible on venue displays, with winners announced and rewards automatically distributed through POS integrator 624.

The proposed invention provides significant advantages over conventional public venue entertainment systems through content integration, where computer vision analysis ensures interactive content enhances rather than disrupts ongoing programming by identifying natural break points and contextually appropriate moments. Real-time contextual relevance is achieved through integration of content analysis with external data sources, creating interactive experiences directly related to current programming that maximize patron engagement. Authenticated venue participation ensures competitive integrity by preventing remote participation through location verification, thereby maintaining the social aspects of venue-based entertainment. Seamless technical integration is maintained as the stream controller preserves signal quality and viewing continuity during content transitions, ensuring technical reliability in commercial venue environments. Finally, scalable multi-user coordination enables simultaneous participation across multiple devices and displays through real-time synchronization, creating venue-wide interactive experiences that can accommodate varying patron participation levels while maintaining system performance and engagement quality.

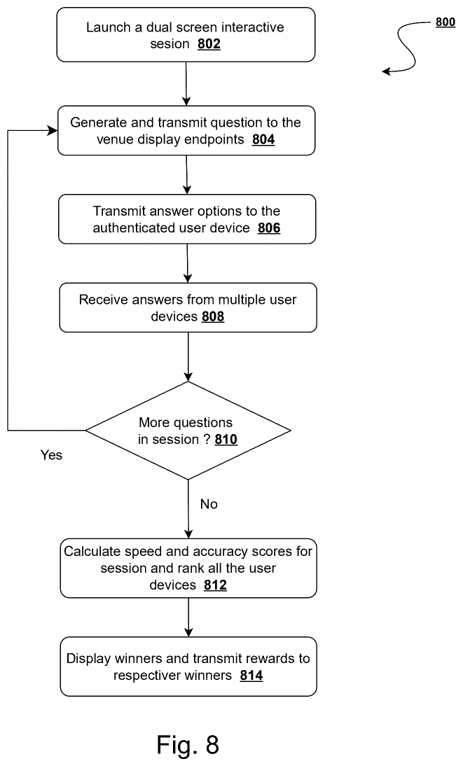

FIG. 8 is a flowchart illustrating method 800 for competitive interactive session, showing the detailed process flow for coordinating multi-user competitive interactions from session launch through reward distribution, according to an embodiment of the invention.

At step 802, central controller 502 may launch synchronized interactive sessions that coordinate presentation of questions or challenges on venue display endpoints 506 while establishing real-time communication with authenticated user devices 504 for user response collection. The synchronization process ensures that all venue displays 506 present identical content simultaneously while user devices 504 receive coordinated input interfaces.

Interaction manager 612 initializes competitive session by coordinating with real-time sync 628 to establish synchronized presentation across venue display endpoints 506. Mobile integrator 626 establishes communication channels with authenticated user devices while user analyzer 622 initializes engagement tracking systems.

At step 804, central controller 502 may coordinate with content processing manager 614 to generate, and transmit questions to venue display endpoints 506. In an embodiment, content processing manager 614 generates questions using contextual data from content analyzer 618 and external data analyzer 616.

In an embodiment, content processing manager 614 may maintains integration capabilities with multiple content provider systems and external services. Content processing manager 614 coordinates transitions between live programming and proprietary interactive content through switching algorithms that preserve viewing experience continuity. This integration framework enables venues to maintain their existing content distribution infrastructure while adding interactive engagement capabilities that coordinate with rather than replace traditional broadcasting systems. Real-time sync 628 coordinates simultaneous question presentation across all venue displays while maintaining visual consistency and timing precision.

Venue display endpoints 506 may present interactive challenges that are visible to all venue patrons and relate directly to analyzed content context. The question display process coordinates timing across multiple display devices and ensures that visual presentation supports competitive interaction among venue patrons.

At step 806, central controller 502 may transmit answer options to authenticated user devices, providing individual mobile interfaces that enable venue patrons to submit responses to displayed questions. The transmission process maintains session synchronization while delivering personalized response interfaces to each participating mobile device.

Mobile integrator 626 may deliver personalized answer interfaces to authenticated user devices, utilizing custom content 607 for option presentation. Interaction manager 612 maintains session synchronization while ensuring response interface consistency across different user devices 504.

At step 808, central controller 502 may receive via mobile integrator 626 answers from multiple user devices simultaneously, processing competitive responses in real-time while maintaining accurate timing records for each participant. The response collection process handles multiple simultaneous inputs while preserving the timing precision necessary for competitive scoring calculations.

Mobile integrator 626 processes simultaneous response collection while interaction manager 612 maintains precise timing records for competitive scoring. User analyzer 622 processes engagement metrics while stream controller 620 manages any display updates during response collection.

At step 810, central controller 502 may determine whether additional questions remain in the current interactive session based on predefined session parameters and real-time engagement metrics.

Interaction manager 612 evaluates session parameters stored in memory 604 against real-time engagement data from user analyzer 622 to determine session continuation. Content processing manager 614 assesses content context for additional question opportunities This determination process considers session duration, user participation levels, and content context to optimize interactive experience length and engagement value.

When additional questions remain, method 800 returns to step 804 to continue the competitive interactive session with subsequent questions and challenges. When the session is complete, the process advances to step 812 for final scoring and ranking calculations.

At step 812, central controller 502 may coordinate with interaction manager 612 to processes competitive scoring using algorithms that consider response timing accuracy and participation consistency. Interaction manager 612 calculates speed and accuracy scores for each participant and ranks all authenticated user devices 504 based on competitive performance metrics. The scoring calculation process considers response timing, answer accuracy, and participation consistency to generate fair and engaging competitive results across all session participants. User analyzer 622 contributes engagement weighting while maintaining fair competition across all authenticated participants.

At step 814, central controller 502 may coordinate with real-time sync to display competition winners on venue display endpoints 506 and transmit reward information to respective winning participants through mobile device interfaces. POS integrator 624 automatically processes reward distribution through venue systems while user analyzer 622 records engagement analytics for future optimization.

The winner announcement process provides venue-wide recognition of competitive results while coordinating with point-of-sale integration systems to automatically distribute earned rewards and incentives to winning participants.

The competitive interactive session method provides distinct advantages for venue entertainment and patron engagement through synchronized multi-user competition, and real-time sync ensures fair competitive timing across all participants while maintaining engaging group dynamics throughout venue spaces. Automated reward integration enables immediate reward distribution without manual intervention through POS integrator 624, creating seamless incentive systems that encourage continued participation. Precision timing and scoring is maintained as interaction manager 612 achieves millisecond-level timing accuracy for fair competition while processing multiple simultaneous responses without performance degradation. Scalable session management is supported through mobile integration that accommodates variable participant numbers while maintaining session quality, enabling flexible venue capacity utilization. Analytics collection is achieved as the user analyzer 622 captures detailed engagement metrics for venue optimization while respecting user privacy through anonymous competitive participation. Finally, contextual question generation ensures that the content processing manager creates relevant questions based on current programming, maintaining patron interest through contextually appropriate competitive challenges that enhance the overall entertainment experience.

The specific data sources, performance thresholds, and hardware examples described herein are illustrative and may vary in other embodiments.

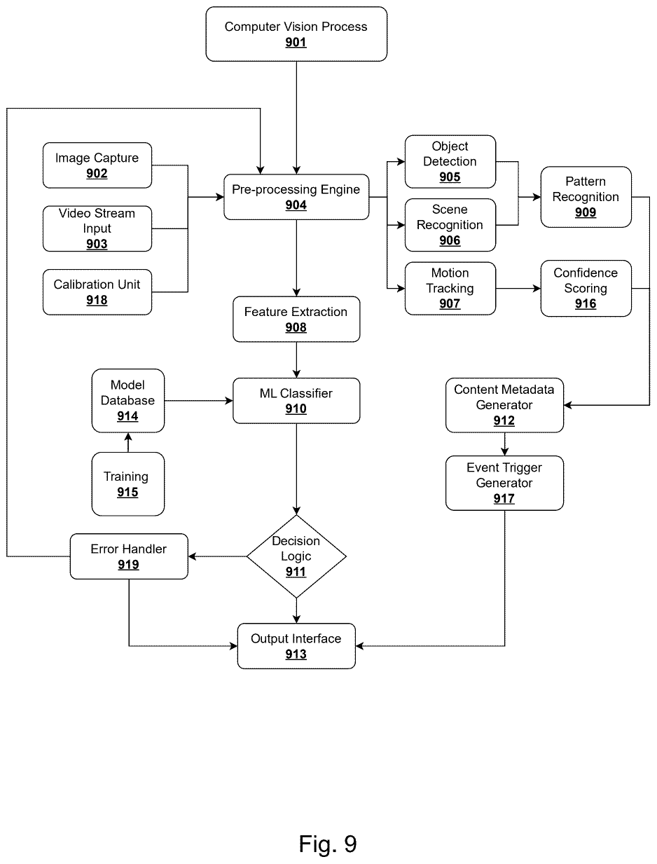

Referring now to FIG. 9, which illustrates a detailed component diagram of computer vision process 901 implemented within central controller 502 in a preferred embodiment. Computer vision process 901 corresponds to computer vision 608 shown in FIG. 6 and provides automated visual analysis capabilities for monitoring live content streams from content source 508 to detect optimal intervention opportunities for interactive content generation. Computer vision process 901 may enable central controller 502 to analyze broadcast content in real-time, identify contextually appropriate moments for patron interaction, and extract visual information necessary for generating relevant interactive sessions that enhance rather than disrupt viewing experiences in watching environments (e.g. a public venue).

Computer vision process 901 may receive visual content through multiple input pathways. Image capture 902 may process individual image frames extracted from content streams, supporting various image formats and implementing frame buffering for temporal analysis. Video stream input 903 mat receive continuous video streams from content source 508, including cable TV boxes streaming services, and the like, processing multiple video protocols including, but not limited to, MPEG-2, MPEG-4, H.264, H.265/HEVC for compatibility with diverse video and broadcast sources. Video stream input 903 may include demultiplexing capabilities to separate video tracks from audio and metadata components, enabling focused visual analysis while preserving timing relationships for synchronized interactive content generation.

Calibration unit 918 may provide calibration parameters to pre-processing engine 904, storing camera intrinsic parameters, color calibration profiles, and system-specific configuration data necessary for accurate visual analysis. Calibration unit 918 may maintain white balance settings, gamma correction values, and color space transformation matrices that ensure consistent visual processing across varying content sources and broadcast formats. This calibration data may enable computer vision process 901 to normalize diverse input sources for uniform analysis regardless of original broadcast characteristics.

Pre-processing engine 904 may receive input from image capture 902, video stream input 903, and calibration parameters from calibration unit 918 to perform initial data conditioning. Pre-processing engine 904 implements image resizing, noise reduction, color space conversion, and lens distortion correction to prepare visual data for analysis. Pre-processing engine 904 may utilize GPU acceleration for real-time processing performance, maintaining synchronization between multiple input streams through timestamp alignment and frame buffering techniques that preserve temporal relationships critical for detecting, for example, sports events and programming transitions. In an embodiment, the pre-processing engine 904 and downstream analysis components of computer vision process 901 operate under real-time performance constraints suitable for continuous broadcast monitoring. The system achieves processing throughput of approximately 30 frames per second at 1080 p resolution with an end-to-end analysis latency of ≤200 milliseconds from frame capture to event-trigger generation. When implemented on GPU-accelerated hardware such as an NVIDIA® DGX Spark™, the pre-processing engine 904 employs parallelized convolution operations and pipelined memory buffering to sustain real-time operation across multiple simultaneous content streams. These parameters ensure that interactive content generated in response to detected broadcast events remains temporally aligned with on-screen programming, maintaining seamless synchronization across venue display endpoints and user devices within the same embodiment of the system.

Pre-processed visual data flows to multiple specialized analysis components operating in parallel. Object detection 905 may identify discrete objects within broadcast content including players, balls, field markers, and on-screen graphics. Object detection 905 may implement convolutional neural networks trained on sports-specific datasets to recognize game elements with high accuracy, output bounding box coordinates and confidence scores for each detected object. This detection capability enables central controller 502 to identify specific game events such as scoring plays that trigger interactive content generation.

Scene recognition 906 may analyze overall visual context to identify venue types, camera angles, and broadcast segments. Scene recognition 906 may distinguish between game play, commercial breaks, studio segments, and crowd shots, providing contextual understanding that informs optimal intervention timing. Scene recognition 906 may generate scene descriptors and semantic labels that content processing manager 614 may utilize to ensure interactive content aligns with current programming context.

Motion tracking 907 may analyze temporal changes across consecutive frames to detect movement patterns indicative of specific sports events. Motion tracking 907 may track, for example, ball trajectories for goal detection, player movements for formation analysis, and camera motion for scene transition identification. Motion tracking 907 may maintain object identities across frames and calculates velocity vectors that enable detection of fast-paced events such as three-point shots, touchdowns, and home runs that create optimal moments for patron interaction.

Feature extraction 908 may process pre-processed visual data to extract discriminative features for classification tasks. Feature extraction 908 may implement deep learning features from pre-trained networks alongside traditional computer vision descriptors, performing dimensionality reduction to optimize feature representation. These extracted features enable ML classifier 910 to perform accurate event classification despite variations in camera angles, lighting conditions, and broadcast quality.

ML classifier 910 may receive extracted features from feature extraction 908 and trained models from model database 914 to classify visual content and detect specific events. ML classifier 910 may support multiple classification paradigms including deep neural networks for complex event recognition and ensemble methods for robust performance across diverse content types. ML classifier 910 may perform multi-class classification to identify, for example, sport types, game events, and programming segments that inform interactive content generation decisions.

Model database 914 stores trained machine learning models specific to different sports and broadcast formats. In some embodiments, model database 914 maintains separate models for football touchdown detection, basketball scoring recognition, baseball home run identification, and commercial break detection. Model database 914 implements version control and A/B testing capabilities that enable continuous improvement of detection accuracy through deployment of updated models without system interruption. In an embodiment, the model database 914 supports continuous improvement of deployed machine-learning models through controlled versioning and containerized deployment. Updated models generated by training 915 or by offline training environments may be packaged within lightweight software containers that include all required inference dependencies. Version control metadata stored in the model database 914 identifies model lineage, training dataset references, validation accuracy, and deployment timestamps. This enables safe rollback to previous model revisions and controlled A/B evaluation of new models while maintaining real-time operational continuity of the same embodiment of the system described in FIG. 9.

Training 915 may perform continuous model improvement using feedback from venue deployments. Training 915 implements transfer learning from pre-trained sports recognition models, fine-tuning performance for specific broadcast characteristics encountered in venue environments. Training 915 updates model database 914 with improved models based on patron engagement metrics and detection accuracy assessments from real-world deployments. In an embodiment, the machine-learning models stored in model database 914 and refined by training 915 may be trained using annotated broadcast footage obtained from sports content libraries. Example datasets may include approximately 500 hours of annotated NFL and NCAA football broadcasts labeled for touchdown, field-goal, and penalty events; 300 hours of NBA basketball footage labeled for three-point shots, free throws, and timeouts; and 250 hours of Major League Baseball broadcasts labeled for home runs, strikeouts, and inning transitions. Each frame or clip in such datasets may include bounding boxes and temporal markers identifying game objects and events. In one implementation, the training 915 may employ transfer learning from pre-trained convolutional neural network architectures (for example, ResNet-50 or EfficientNet) fine-tuned on the annotated datasets. Model training and validation may be performed using industry-standard frameworks such as PyTorch™ or TensorFlow™, executing on GPU-accelerated hardware such as an NVIDIA® DGX Spark™ or A100 to achieve real-time inference capability suitable for deployment within the central controller 502.

Pattern recognition 909 may receive outputs from object detection 905 and scene recognition 906 to identify higher-level patterns and relationships. Pattern recognition 909 may perform spatial relationship analysis to understand game formations, temporal pattern detection to recognize recurring events, and composite object recognition to identify complex game situations. Pattern recognition 909 may utilize these patterns to detect nuanced events such as power plays, fast breaks, and strategic timeouts that create compelling interactive opportunities.

Confidence scoring 916 may evaluate reliability of detection results from motion tracking 907 and other analysis components. Confidence scoring 916 may compute detection confidence based on classifier probabilities, tracking consistency across frames, and ensemble agreement when multiple detection methods are employed. Confidence scoring 916 may generate reliability indicators that decision logic 911 uses to determine whether detected events warrant interactive content generation.

Decision logic 911 may receive classification results from ML classifier 910 and implement decision processes for interactive content triggering. Decision logic 911 may evaluate confidence thresholds, temporal consistency requirements, and venue-specific business rules to determine appropriate actions. Decision logic 911 may route high-confidence detection results to output interface 913 for interactive content generation while directing low-confidence or error conditions to error handler 919 for appropriate processing. In a preferred embodiment, output interface 913 may communicate with external integration points 608 (shown in FIG. 6), enabling computer vision process 901 to trigger downstream services including POS integrator 624, mobile integrator 626, and real-time sync 628 for coordinated interactive session management.

In an embodiment, performance metrics are defined to quantify event-detection accuracy and system responsiveness. Confidence scoring 916 may assign a normalized probability value C∈[0,1] to each detected event. Detection outputs with C≥0.85 are treated as high-confidence and automatically routed to decision logic 911 for event triggering, whereas outputs with C<0.85 are re-evaluated or passed to error handler 919 for secondary analysis. In one example deployment, the computer-vision process 901 achieves a mean average precision (mAP) of approximately 0.92 across football, basketball, and baseball event classes with a false-positive rate below 5 percent. Latency from frame capture to event trigger generation is maintained within 300 milliseconds for live 1080 p broadcast streams, ensuring interactive content remains temporally aligned with ongoing programming.

Error handler 919 may process exceptional conditions and low-confidence scenarios identified by decision logic 911. Error handler 919 may implement retry mechanisms with adjusted parameters, fallback to alternative detection algorithms, and graceful degradation strategies that maintain system operation despite challenging content conditions. Error handler 919 may forward recovered results or error status information to output interface 913 for appropriate system response.

Content metadata generator 912 may receive pattern information from pattern recognition 909 and confidence scores from confidence scoring 916 to create structured metadata describing detected events. Content metadata generator 912 may generate event metadata including event type, participants, timestamps, and relevance scores that content processing manager 614 utilizes for interactive content creation. Content metadata generator 912 may format output in JSON for seamless integration with downstream components.

Event trigger generator 917 may receive metadata from content metadata generator 912 and generates event triggers that initiate interactive content creation. Event trigger generator 917 may implement event detection logic to identify significant moments including, for example, touchdowns, three-point shots, home runs, and commercial breaks that warrant patron interaction. Event trigger generator 917 may generate timestamped notifications with priority levels and suggested content types that interaction manager 612 uses to coordinate interactive session launches.

Output interface 913 serves as an output stage for computer vision process 901, receiving processed results from decision logic 911, error handler 919, and event trigger generator 917. Output interface 913 may communicate with external integration points 608 shown in FIG. 6, enabling computer vision process 901 to trigger downstream services including POS integrator 624, mobile integrator 626, and real-time sync 628 for coordinated interactive session management. Output interface 913 may implement message queue protocols for asynchronous communication with interaction manager 612, content processing manager 614, and stream controller 620. Output interface 913 may include buffering and rate limiting capabilities to manage downstream system requirements while maintaining real-time responsiveness.

In operation, computer vision process 901 continuously monitors content streams from content source 508 through coordinated analysis pipelines. Raw video frames captured by image capture 902 or video stream input 903 undergo pre-processing with calibration parameters from calibration unit 918. Pre-processing engine 904 distributes conditioned data to parallel analysis paths where object detection 905, scene recognition 906, motion tracking 907, and feature extraction 908 extract different aspects of visual information simultaneously.

Detection results may flow through pattern recognition 909 for higher-level understanding while confidence scoring 916 may assess reliability. ML classifier 910 performs event classification using models from model database 914, with training 915 continuously improving detection accuracy. Decision logic 911 evaluates results against confidence thresholds, routing high-confidence detections through content metadata generator 912 and event trigger generator 917 to output interface 913 for downstream processing.

Computer vision process 901 may enable central controller 502 to automatically detect optimal intervention opportunities in live broadcast content without manual monitoring. By identifying natural break points such as commercial segments, timeouts, and halftime periods, computer vision process 901 may ensure interactive content enhances rather than disrupts patron viewing experiences. Real-time event detection capabilities enable contextually relevant interactive content generation that leverages excitement of live sports moments, creating compelling patron engagement opportunities for viewers in, for example, sports bars, restaurants, and entertainment venues.

The modular architecture of computer vision process 901 may provide technical advantages including parallel processing for reduced latency, independent component optimization without system-wide impacts, and robust error handling for reliable operation in production environments. Alternative embodiments may implement end-to-end deep learning architectures, edge computing distributions, or cloud-based processing while maintaining real-time responsiveness through predictive caching and speculative execution strategies.

The skilled person will be aware of a range of possible modifications of the various embodiments described above. Accordingly, the present invention is defined by the claims and their equivalents.

What is claimed is:

1. A system for enabling interactive sessions in a venue through content orchestration, the system comprising:
a central controller positioned between a content source and a plurality of venue display endpoints, the central controller comprising one or more processors, a memory, and a plurality of programming instructions stored in the memory, the plurality of programming instructions when executed by the one or more processors causes the one or more processors to:
monitor content streams using computer vision analysis to detect content segmentation and optimal intervention opportunities;
responsive to detection of an optimal interactive moment in the content streams, generate and transmit, contextual interactive content generated based on real-time content analysis, wherein the contextual interactive content comprises questions, challenges, or competitive elements dynamically created from currently displayed programming;
display, on venue display endpoints, interactive participation invitations, wherein the invitations include scannable codes that enable user access to interactive sessions;
receive, via a mobile integrator, user interaction requests through scanning of the scannable codes via user devices of venue patrons;
determine, using location services, whether the user devices are physically present within the venue before permitting participation in interactive sessions; and
responsive to determining that the user devices are present within venue, coordinate synchronized dual-screen interactive sessions, wherein the venue display endpoints present interactive content and the user devices of authenticated patrons serve as response input interfaces.

2. The system of claim 1, wherein to coordinate synchronized dual-screen interactive sessions, the plurality of programming instructions when executed by the one or more processors causes the one or more processors to:
present, using a real time sync, identical interactive content simultaneously to venue display endpoints;
coordinate authenticated user devices to transition from authentication interfaces to individual response interfaces for personal input; and
maintain synchronization timing between venue display content presentation and user device response collection across the authenticated user devices.

3. The system of claim 1, wherein the plurality of programming instructions when executed by the one or more processors causes the one or more processors to:
process simultaneous responses from the user devices to generate real-time competitive scoring and dynamic leaderboard updates;
determine competition results through the scoring calculations and patron ranking across authenticated user devices; and
coordinate seamless transitions back to content streams while storing engagement analytics for venue optimization.

4. The system of claim 3, wherein to coordinate synchronized dual-screen interactive sessions, the plurality of programming instructions when executed by the one or more processors causes the one or more processors to:
responsive to the generation of the scoring calculations and patron ranking across authenticated user devices, automatically distribute, via a point-of-sale (POS) integrator, rewards based on scoring and patron ranking integration.

5. The system of claim 1, wherein to determine whether the user devices are physically present within the venue, the plurality of programming instructions when executed by the one or more processors causes the one or more processors to:
implement GPS-based verification systems that authenticate user device presence within venue premises; and
utilize network-based positioning to confirm physical presence, wherein the authentication prevents remote participation by users outside venue boundaries.

6. The system of claim 1, wherein to coordinate the dual-screen interactive sessions, the plurality of programming instructions when executed by the one or more processors causes the one or more processors to:
coordinate synchronized interactive sessions by transitioning venue display endpoints to present questions; and
establish real-time bidirectional communication with the authenticated user devices.

7. The system of claim 1, wherein the system is configured to operate in public venue environments comprising sports bars, restaurants, hotels, and entertainment establishments, and wherein the central controller device coordinates multiple venue display endpoints and multiple user devices simultaneously to create venue-wide interactive experiences.

8. A computer-implemented method for enabling interactive sessions in a venue through content orchestration, the method comprising:
monitoring, by a central controller positioned between a content source and a plurality of venue display endpoints, content streams using computer vision analysis to detect content segmentation and optimal intervention opportunities;
responsive to detection of an optimal interactive moment in the content streams, generating and transmitting, by the central controller, contextual interactive content based on real-time content analysis, the contextual interactive content comprising questions, challenges, or competitive elements dynamically created from currently displayed programming;
displaying, on the venue display endpoints, interactive participation invitations that include scannable codes enabling user access to interactive sessions;
receiving, via a mobile integrator of the central controller, user interaction requests generated by user devices of venue patrons through scanning of the scannable codes;
determining, by location services of the central controller, whether the user devices are physically present within the venue before permitting participation in the interactive sessions; and
responsive to determining that the user devices are present within the venue, coordinating synchronized dual-screen interactive sessions in which the venue display endpoints present the interactive content and the user devices of authenticated patrons serve as response input interfaces.

9. The method of claim 8, further comprising:
presenting, using a real-time synchronization component, identical interactive content simultaneously to the plurality of venue display endpoints;
coordinating the authenticated user devices to transition from authentication interfaces to individual response interfaces for personal input; and
maintaining synchronization timing between venue display content presentation and user-device response collection across the authenticated user devices.

10. The method of claim 8, further comprising:
processing, by the central controller, simultaneous responses received from the user devices to generate real-time competitive scoring and dynamic leaderboard updates;
determining competition results through scoring calculations and patron ranking across the authenticated user devices; and
coordinating seamless transitions back to the content streams while storing engagement analytics for venue optimization.

11. The method of claim 10, further comprising:
automatically distributing, via a point-of-sale (POS) integrator of the central controller, rewards to authenticated user devices based on the scoring calculations and patron rankings.

12. The method of claim 8, wherein determining whether the user devices are physically present within the venue comprises:
implementing GPS-based verification to authenticate user-device presence within venue premises; and
utilizing network-based positioning to confirm physical presence, thereby preventing remote participation by users outside venue boundaries.

13. The method of claim 8, further comprising:
transitioning the venue display endpoints from live content presentation to display of questions and interactive elements; and
establishing real-time bidirectional communication between the central controller and the authenticated user devices for synchronized data exchange during the interactive sessions.

14. The method of claim 8, wherein the venue is a public entertainment establishment selected from the group consisting of sports bars, restaurants, hotels, and entertainment venues; and wherein the central controller coordinates multiple venue display endpoints and multiple user devices simultaneously to create venue-wide interactive experiences.
